(19) United States
(12) Patent Application Publication
(10) Pub. No.: US 2022/0134933 A1
(43) Pub. Date: May 5, 2022

(54) AUTOMATED GUIDED VEHICLE

(71) Applicant: A&A LOGISTIK-EQUIPMENT GMBH & CO. KG, Heidenau (DE)

(72) Inventor: Gerhard HABEDANK, Seevetal (DE)

(73) Assignee: A&A LOGISTIK-EQUIPMENT GMBH & CO. KG, Heidenau (DE)

(21) Appl. No.: 17/431,467

(22) PCT Filed: Feb. 17, 2020
(86) PCT No.: PCT/EP2020/054096

§ 371 Date: Aug. 17, 2021

(30) Foreign Application Priority Data
Feb. 18, 2019 (DE) 10 2019 104 051.5

(51) Int. Cl. B60P 1/64; B60P 1/52; G05D 1/02; B60P 1/36

(52) U.S. Cl. CPC B60P 1/6427; B60P 1/52; G05D 2201/0216; B60P 1/36; G05D 1/021

(57) ABSTRACT

The present invention relates to an automated guided vehicle (1) having a frame (10) designed to receive a material handling accessory (3). The automated guided vehicle (1) is characterized by at least one displacement element (14) which is designed to be moved in and out in at least one horizontal direction (Y) relative to the frame (10) at least to one side beyond the external dimensions of said frame, wherein the displacement element (14) is further designed to carry the material handling accessory (3) along with it.

The present invention relates to an automated guided vehicle according to the preamble of claim 1.

In manufacturing companies, it is always necessary to supply workstations with parts that are required there for processing and/or assembly, for example. This applies in particular to mass production, which is usually implemented as assembly line production, for example using conveyor systems or assembly lines. The workstations can be operated by people, by automation systems and/or by industrial robots, for example as robot cells. This also applies to individual processing stations.

In any case, it is customary to transport individual parts, assemblies and the like to the individual workstations and keep them there so that the activities at the workstations can be carried out continuously and without interruption. For this purpose, the parts are transported to the workstation, picked up and made available there and used as needed, for example, to carry out an assembly step of the workstation. Parts processed by the workstation may also have to be transported away.

In order to facilitate and accelerate the transport of the parts, the parts are usually combined into larger units. This is usually done using material handling accessories such as pallets, containers, bins, pallet cages and storage boxes, which make the parts collectively manageable by forming loading units. The material handling accessories can be transported as a whole and fed to the workstation. Empty material handling accessories or material handling accessories with processed parts can be transported away from the workstations. The material handling accessories can also be referred to as loading aids or load carriers.

In any case, the transport of the load carriers can be carried out by means of floor conveyors such as, for example, lift trucks, forklifts and the like, which usually have to be moved or operated by at least one person.

Alternatively, it is increasingly known to use automated guided vehicles (AGVs) for such transport tasks. An automated guided vehicle is understood to mean a floor conveyor with its own drive, which can be controlled automatically and contactlessly guided. The load carriers can be carried on top of the AGV or pulled behind it and thus brought to the workstation or removed from there. In addition to production, comparable tasks and solutions can also be found in other logistics applications such as warehousing, order picking and internal transport.

In any case, it has heretofore been known that the transfer of a load carrier, which is carried on a floor conveyor, from the floor conveyor to a workstation is carried out essentially horizontally by means of the load handling equipment of the floor conveyor, which can be designed as roller conveyors, chain conveyors or belt conveyors, for example. In addition, the workstation to be supplied can have driven rollers or conveyor belts as transfer technology. As a result, the load carrier can be moved horizontally between the floor conveyor and the workstation in order to be transferred in one or the other direction.

In this case, however, it is necessary that for the transfer of the load carrier in both directions a horizontal movement can also be carried out by the device which has the load carrier and wants to deliver it. In other words, a load carrier can be transferred from a floor conveyor to a workstation, for example by means of a driven roller conveyor of the floor conveyor. However, in order to transfer a load carrier from the workstation to the floor conveyor, the workstation must also have, for example, a powered roller conveyor in order to be able to pass a load carrier to the floor conveyor. This leads to a corresponding effort in the workstations, which is reflected in corresponding costs and can require installation space. This can result in additional costs for production and operation for each transfer point of the load carriers due to the consumption of electrical energy, maintenance costs and the like.

These costs arise in particular if an existing production or other application of logistics which was previously supported by people by means of manually moved or operated floor conveyors is to be converted to cooperation with automated guided vehicles. The workstations then have to be retrofitted with floor conveyors, such as roller conveyors, in order to be able to transfer load carriers to an automated guided vehicle, as this activity was previously carried out by people. This can lead to a not inconsiderable effort with correspondingly high costs.

The movements of, for example, the driven roller conveyors of the floor conveyor and the workstation must be synchronized with each other so that, for example, a non-powered and thus stationary roller conveyor of the floor conveyor cannot block or hinder the transfer of the load carrier from the workstation. This in turn can lead to an increased effort in data processing and communication in the form of computing power, transmitting and receiving components and the like, both in the case of the floor conveyor device and in the workstation. In particular, communication between the floor conveyor and the workstation may be necessary as a result. This can be the case in particular with automated guided vehicles.

One object of the present invention is to provide an automated guided vehicle of the type described at the outset which can automatically take a material handling accessory from a workstation or the like and transfer it to the workstation or the like. In particular, this should be done as simply, inexpensively and/or flexibly as possible. At least an alternative to known solutions should be provided.

The object is achieved according to the invention by an automated guided vehicle having the features of claim 1. Advantageous further developments are described in the dependent claims.

The invention thus relates to an automated guided vehicle having a frame which is designed to accommodate a material handling accessory. Such automated guided vehicles are known and are already used to transport material handling accessories as described above. The frame can in particular be box-shaped, rectangular and flat.

The automated guided vehicle according to the invention is characterized by at least one displacement element which is designed to be moved in or out in at least one horizontal direction relative to the frame at least on one side beyond the external dimensions of said frame, the displacement element also being designed to carry the material handling accessory along with it. The external dimensions of the frame of the automated guided vehicle can be formed by its outer rim or by its outer edge in the relevant horizontal direction.

The horizontal direction can be both the longitudinal direction and the transverse direction of the automated guided vehicle, which extend perpendicular to one another and both extend perpendicular to the vertical direction. The choice in which of the two horizontal directions the displacement element is movable can be made depending on the application for which the automated guided vehicle according to the invention is to be implemented.

In this way, a material handling accessory can be picked up and deposited depending on the configuration of the displacement element or its horizontal direction of travel, which can make these processes comparatively simple and implementable with as little effort and energy as possible, because no lifting of the weight of the material handling accessory is required. For this purpose, the region of the automated guided vehicle, such as its upper side of the frame, which can accommodate the material handling accessory, can be fixedly arranged at the same height as the corresponding receiver of a workstation, so that no height difference has to be overcome. Alternatively, the region of the automated guided vehicle that can accommodate the material handling accessory can also be designed to be movable in the vertical direction, so that this region of the automated guided vehicle, depending on the workstation, can be brought to the same height as the corresponding receiver of the workstation. Although this can lead to an increased design effort and to at least one further drive, it can increase the flexibility of the use of the automated guided vehicle according to the invention.

It is also conceivable to design the displacement element, preferably including a displacement element guide described in more detail below, to be rotatable relative to the frame, preferably by approx. 90°, so that the displacement element, depending on the rotational position, can be moved in and out in the transverse direction as a horizontal direction or in the longitudinal direction as a horizontal direction. Although this can lead to an increased design effort and to at least one further drive, it can increase the flexibility of the use of the automated guided vehicle according to the invention.

The displacement element is preferably designed to be moved in the transverse direction of the automated guided vehicle, i.e. perpendicular to the longitudinal direction, which usually corresponds to the direction of travel or movement or to the preferred direction of travel or movement of the automated guided vehicle. The automated guided vehicle can thus preferably pick up and deliver the material handling accessory from the side, which can be advantageous in that the automated guided vehicle approaches a workstation laterally in its longitudinal direction, direction of travel or direction of movement, and the material handling accessory is laterally transferred or taken in the transverse direction, and then continue its journey in the previous direction of movement or the direction opposite thereto. This can avoid additional maneuvering movements of the automated guided vehicle in relation to the workstation.

The displacement element can be designed as a movable part of a rail system, the stationary part of which can be connected to the frame in a fixed manner as a displacement element guide. In this way, relative mobility of the displacement element relative to the frame can be made possible. The displacement element can be mounted so as to be movable relative to the frame by means of a sliding guide, a roller guide and the like.

The movement of the displacement element relative to the frame can be implemented using different drive principles. For example, a cylinder can be extended and retracted in one or more stages in the horizontal direction in order to allow the displacement element to be moved out and in. For this purpose, the cylinder can be designed to be variable in length and can be fixedly arranged with one end on the displacement element guide or on the frame and with the opposite end on the displacement element. The cylinder can be operated hydraulically or pneumatically.

An electric drive can preferably be used to allow the displacement element to be moved out and in. This can be advantageous, because electrical energy from the automated guided vehicle can be used directly for the electrical drive and does not have to be converted into hydraulic or pneumatic pressure. The movement can be carried out directly, for example by means of at least one direct linear drive, or indirectly, for example by means of an electric drive, for example as a spindle drive in combination with a horizontally aligned lifting scissor assembly. This can be done in one or more stages.

An electrically driven rack and pinion drive can particularly preferably be used and can allow a comparatively large travel path. In particular, this can be made possible on both sides. A rack and pinion drive can usually also be implemented in a space-saving and/or economical manner.

The movement of the displacement element can be carried out at least on one side of the frame of the automated guided vehicle, i.e. in the case of a movement in the transverse direction, either to the left or to the right side. This can keep the implementation of the guidance of the displacement element and its drive simpler than in the case of bilateral displaceability, which, however, can increase the flexibility of the automated guided vehicle, as will be described in more detail below.

As a result, the displacement element can be moved out beyond the external dimensions of the frame of the automated guided vehicle in order to approach a material handling accessory to be picked up that is located in a workstation, or to bring a material handling accessory to be deposited closer to a workstation which is to receive the material handling accessory. The distance that is to be bridged by the displacement element beyond the external dimensions of the frame of the automated guided vehicle to the workstation can depend on the application, so that the displacement element can be designed accordingly. Usually, the automated guided vehicle can be positioned at a distance from the workstation that is as small as possible while still safely preventing a collision.

The material handling accessory can be carried along by the displacement element depending on the application and the material handling accessory. A positive and/or non-positive connection can be established between the displacement element or a component of the displacement element and the material handling accessory, so that the material handling accessory can be moved by or guided along with the displacement element. This applies both to a material handling accessory picked up from the automated guided vehicle that is to be delivered to a workstation by moving the displacement element together with the material handling accessory, and, vice versa, when a material handling accessory is removed from a workstation by means of the displacement element to the automated guided vehicle. If the material handling accessory has been delivered to a workstation, the connection can be released. If the material handling accessory was picked up by the automated guided vehicle, the connection can remain in place in order to be able to hold the material handling accessory securely during the journey.

According to the invention, the automated guided vehicle can automatically take a material handling accessory from a workstation or the like and transfer it to the workstation. In this way, the need for the workstation to transfer a material handling accessory can be avoided, which can avoid corresponding costs for the workstation, in particular in the case of retrofitting. Coordination between the automated guided vehicle and the workstation can also be avoided in the case of a transfer in both directions, because this can be carried out automatically by the automated guided vehicle alone.

A displacement element can be used which can be arranged, for example, on the frame of the automated guided vehicle in such a way that the displacement element can be moved into an intermediate space in the frame of a material handling accessory in order to be able to connect there to the material handling accessory and carry it along with it. In this case, the displacement element can be arranged on the frame of the automated guided vehicle approximately in the middle in the direction perpendicular to the horizontal direction, so that tilting of the material handling accessory during the movement with the displacement element can be avoided.

Alternatively, two displacement elements can also be used which can be arranged on the frame of the automated guided vehicle in such a way that each displacement element can be moved into a fork receptacle of the frame of a material handling accessory in order to be able to connect there to the material handling accessory and carry it along with it. As a result, the displacement elements can be used in a manner comparable to the forks of a forklift truck or the like.

According to one aspect of the invention, the displacement element is designed to be extended and retracted in at least one horizontal direction relative to the frame on both sides beyond its external dimensions. This can increase the flexibility of the applications of the automated guided vehicle, because material handling accessories can now be delivered and picked up from both sides. Thus, the automated guided vehicle can, for example, move laterally parallel to a workstation in both directions and, depending on the orientation, deliver or pick up the material handling accessory to the left or to the right. A possibly required turning of the automated guided vehicle in order to reach the side to which the displacement element can be moved to reach the workstation can thus be eliminated. This can simplify the planning of the travel paths of the automated guided vehicle and save time.

According to a further aspect of the invention, the frame is designed to receive the material handling accessory onto itself in the vertical direction, at least essentially, preferably completely. In this way, a purely horizontal movement of the material handling accessory can be facilitated, so that lifting of the material handling accessory can be avoided, which could mean additional design effort and energy. For this purpose, the automated guided vehicle or its frame can be designed to be flat enough in the vertical direction, at least in portions, that the material handling accessory can be picked up and released as described above.

In this case, the material handling accessory can be received in the vertical direction, at least essentially, onto the automated guided vehicle or onto its frame, so that the automated guided vehicle can also be dimensioned smaller in the horizontal directions and the received material handling accessory can project beyond the external dimensions of the automated guided vehicle or its frame. As a result, the automated guided vehicle can be more space-saving, lighter and/or more energy-saving.

Preferably, however, the material handling accessory is completely received in the vertical direction onto the automated guided vehicle or onto its frame, which can increase the stability of the movement of the automated guided vehicle and the movement of the displacement element. This applies in particular when the displacement element is to be extendable relatively far beyond its external dimensions in relation to the extent of the automated guided vehicle in this direction, because this can lead to a comparatively large lever arm with a correspondingly large moment.

Particularly preferably, the horizontal dimension of the frame and preferably of the entire automated guided vehicle can correspond to the dimensions of the material handling accessory to be transported. This allows a compromise to be achieved between the properties described above.

According to a further aspect of the invention, the displacement element is arranged in the vertical direction on top of the frame and below the received material handling accessory. In other words, the displacement element is arranged between the frame and the received material handling accessory. In this way, the displacement element can be arranged to save space as much as possible and in the immediate vicinity of the material handling accessory in order to be able to move it as described above.

According to a further aspect of the invention, the displacement element is designed to automatically connect to the material handling accessory and to automatically release from the material handling accessory. In other words, the connection and release can be carried out automatically by the displacement element, so that this function of the automated guided vehicle can also be carried out automatically, i.e. without additional user intervention. This can also automate this function.

According to a further aspect of the invention, the displacement element has at least one gripper element which is designed to grip the material handling accessory. In this way, a connection between the displacement element and the material handling accessory can be established so that the displacement element can carry the material handling accessory with it as described above. This connection can also be canceled again in order for the displacement element to release the material handling accessory again. Gripping and releasing can be carried out, for example, by reaching behind the material handling accessory at a point, so that the material handling accessory can be pulled in at least one direction by the displacement element by means of its gripper element. The gripping is preferably carried out as a double-sided gripping around a point of the material handling accessory, so that a secure connection is created and/or the material handling accessory can be pulled in both directions by the displacement element by means of its gripper element. This can increase the possibilities of the movements which the material handling accessory can carry out with the displacement element.

According to a further aspect of the invention, the displacement element has at least one drive element which is designed to move the gripper element in the horizontal direction relative to the displacement element at least on one side, preferably on both sides. In this way, two movements can be combined with one another in order to increase the distance the material handling accessory can be moved in relation to the automated guided vehicle and in relation to the workstation. The movement of the gripper element relative to the displacement element in the horizontal direction can be carried out as described above for the displacement element, for example by means of an electric linear drive or by means of a drive belt and the like, as will be described in more detail below.

As described above, the displacement element itself can be displaced beyond the dimensions of the frame of the automated guided vehicle in the horizontal direction. As a result, the displacement element or its gripper element can also be brought into connecting contact with a material handling accessory, which is picked up by a workstation, if there is a distance in this horizontal direction between the corresponding side of the automated guided vehicle and the material handling accessory. This contact can be sufficient to pull the material handling accessory towards the automated guided vehicle and pick it up in such a way that the automated guided vehicle can move the material handling accessory along with it and thus transport it, as described above.

According to the present aspect of the invention, however, the picking up of the material handling accessory can be improved by the gripper element being movable relative to the displacement element itself in the same horizontal direction as the displacement element relative to the frame of the automated guided vehicle. As a result, the material handling accessory can be pulled towards the displacement element by the gripper element, which can be moved away from the workstation and thus towards the automated guided vehicle, so that the material handling accessory can be picked up at least partially or completely by the displacement element. Once this movement has been completed, the displacement element can be moved towards the automated guided vehicle as described above in order for the automated guided vehicle to pick up the material handling accessory. The movement of the displacement element relative to the frame of the automated guided vehicle can as a result be shorter than without the use of the movable gripper element, because a certain distance of the total movement of the material handling accessory can now be covered by the gripper element. This can simplify the implementation of the mobility of the displacement element. The displacement element can also be given greater stability in this way or the same stability can be achieved with less effort, because the lever arm which can be formed by the displacement element can be shortened.

Providing the mobility of the gripper element on both sides in the horizontal direction can be advantageous in that, analogously to the previously described movement for receiving a material handling accessory in the opposite direction, a received material handling accessory can be deposited. This can increase the flexibility and the possibilities of using the automated guided vehicle according to the invention.

According to a further aspect of the invention, the drive element is an endless closed drive element which is guided essentially in the horizontal direction around at least one drive and around at least one deflection element. This can be a particularly simple, robust, energy-efficient, space-saving and/or inexpensive way of implementing the desired mobility. In particular, the above-described movement on both sides can be implemented in this way with the aforementioned advantages.

According to a further aspect of the invention, the endless closed drive element is a drive belt, a drive chain or a drive band. This can allow the aspects described above to be implemented with simple, robust and/or inexpensive means.

According to a further aspect of the invention, the gripper element has two gripper half-elements which are arranged on the endless closed drive element in order to be opened by the deflection of the endless closed drive element on the drive and/or on the deflection element and be closed by the movement between the drive and the deflection element. In other words, the two gripper half-elements, which together form the gripper element, are designed and arranged directly next to each other on the endless closed drive element on its outwardly directed side, so that the two gripper elements, in a straight translational movement in the horizontal direction, together enclose a recess from which a part of a material handling accessory, such as a vertically aligned grip element of a frame of the material handling accessory, can be picked up and thus gripped by the gripper element of the displacement element. As a result, the material handling accessory can be moved together with the gripper element or the displacement element.

However, this also makes it possible to easily open the gripper element. If the gripper element is guided via a deflection, which can be implemented by a deflection element, such as a deflection roller, or via a drive, such as a drive roller, the drive element, for example an endless closed drive belt, is curved around the deflection element. This movement is transferred to the two outwardly directed gripper half-elements, which are thereby curved apart, which can lead to an opening of the gripper element. If the drive element is now stopped at this point, an opened gripper element can pick up or release a corresponding grip element of the material handling accessory. This can make it possible to realize the function of opening and closing the gripper element without additional means and solely by moving the drive element.

According to a further aspect of the invention, the gripper element is designed to be moved by the drive element laterally relative to the displacement element. In other words, the gripper element can be moved laterally along the displacement element by means of the drive element. This can protect the gripper element from external influences and in particular from collisions, because the gripper element and the drive element protrude in the vertical direction from, for example, a cover of the displacement element and can thereby be protected. The lateral movement of the gripper element can also facilitate the use of an endless closed drive element, as described above, because its endless closed course in the horizontal direction can be implemented more easily in terms of design than with an arrangement perpendicular to the horizontal direction.

According to a further aspect of the invention, the displacement element has at least one pair of gripper elements which are designed to grip the material handling accessory together, the two gripper elements being arranged spaced apart from one another perpendicular to the horizontal direction of extension or retraction. In other words, the two gripper elements can move parallel to each other in the horizontal direction. As a result, the properties of the gripper element described above can be used twice, which can increase the stability of the connection between the displacement element and the material handling accessory. In particular, by offsetting the two gripper elements perpendicular to the direction of movement, tilting during the movement can be avoided. Two gripper elements together can also apply the same force as a single gripper element with a more powerfully dimensioned drive, but smaller components can be used for this, which can reduce the space required to implement this function. These components can also be arranged in a more space-saving manner than fewer larger components. Furthermore, identical parts can be used to implement the two gripper elements, thereby reducing costs.

According to a further aspect of the invention, the displacement element has at least one pair of gripper elements which are designed to grip the material handling accessory together, the two gripper elements being arranged spaced apart from one another in the horizontal direction of extension and retraction. In this way, the material handling accessory can be gripped twice, as described above, along the horizontal direction of movement, thereby increasing the stability of the material handling accessory picked up by the automated guided vehicle. This can benefit the safety of the movement of the automated guided vehicle or its surroundings and, if necessary, allow higher speeds of the automated guided vehicle during movement, which can lead to time savings.

According to a further aspect of the invention, the two gripper elements are arranged on a common drive element spaced apart from one another as far as two corresponding grip elements of the material handling accessory are arranged spaced apart from one another in the horizontal direction. This makes it possible for a grip element of the material handling accessory facing the automated guided vehicle to be gripped as described above by an open gripping element of the displacement element of the automated guided vehicle and then be moved along with it until another grip element of the material handling accessory in the same way can be gripped by a further open gripping element of the displacement element of the automated guided vehicle. This makes it possible to ensure in a simple manner that the material handling accessory can be gripped twice along the horizontal direction of movement. The arrangement of the two gripper elements of the displacement element can be fixedly provided, at least for a certain type of material handling accessory, because material handling accessories usually have standardized dimensions.

At least one of the two gripper elements can be arranged at different positions of the displacement element in order to be able to use the properties and advantages described above for material handling accessories of different extension in the transverse direction, as described above. In other words, the distance between the two gripper elements can be varied and the distance between the grip elements of the material handling accessory can be adapted in the transverse direction in order to be able to handle material handling accessories of different widths as described above. More than two gripper elements can also be arranged on the common drive element that have different distances from one another, which distances respectively correspond to different distances between the grip elements of different material handling accessories in the transverse direction, so that different material handling accessories can be handled as described above with the automated guided vehicle according to the invention, without having to reposition a gripper element. This can increase the flexibility of the application of the automated guided vehicle according to the invention.

According to a further aspect of the invention, the frame has at least one roller conveyor, preferably at least one pair of roller conveyors, which is designed to receive the material handling accessory by rolling. In this way, the mobility of the material handling accessory relative to the automated guided vehicle can be facilitated, because a frame of the material handling accessory can be rolled over the rollers of the roller conveyor, for example by means of feet, brackets or the like. In this way, the picking up and the depositing of the material handling accessory for the displacement element or for the gripper element can be simplified. In particular, the drives involved in the displacement element and the gripper element can be designed to be less powerful, which can save on installation space and acquisition costs and reduce energy consumption.

In this case, roller conveyors are to be provided with regard to their number and their arrangement perpendicular to the horizontal direction of the movement of the extension or retraction in such a way that the material handling accessory to be transported can be picked up as described above. If the arrangement of the feet, brackets or the like of the material handling accessory is known, the roller conveyor or the pair of roller conveyors can be provided accordingly in the automated guided vehicle. If this is not known or if material handling accessories with different sizes or arrangements of feet, brackets or the like are to be accommodated, it can be advantageous to provide a plurality of roller conveyors next to each other in the automated guided vehicle in order to be able to use the automated guided vehicle as flexibly as possible. This can increase the costs due to the use of the plurality of roller conveyors but lead to an automated guided vehicle that can be used as universally as possible.

In other words, the invention relates to a gripping table which is installed on an AGV and can be controlled by the vehicle controller. The AGV can have roller conveyors at the same loading height as the workstation. The gripping table can reach into the forklift eyes of a load carrier.

In an extendable gripping table, two chains running in parallel can be connected to a gear unit. Gripper elements can be installed on the chain. The gripper elements can open when driving onto the front deflection roller. When the gripping table is moved laterally, the opened gripper elements can be positioned on the fork eyes of the load carrier. By moving the chains in the opposite direction, the gripper elements can close and the load carrier can be moved in the direction of the AGV onto the roller conveyors of the AGV. If the load carrier is on the AGV, two further gripper elements mounted on the chain can engage in the rear eyes of the load carrier. In the transport position, the load carrier can be secured in four gripper elements, and the gripping table can be moved to the middle position so that the load carrier can be located within the vehicle contour for transport on the AGV.

This function can be carried out from both directions. The load carrier can be placed in a parking space of a workstation in both directions. Furthermore, a load carrier can, for example, be picked up on the right side of the AGV and deposited on the left side of the AGV, and vice versa.

With the solution according to the invention, an AGV can also remove a load carrier from a non-driven roller conveyor of a workstation or push the load carrier onto a non-driven roller conveyor of a workstation. The AGV can pick up and drop off the load carrier in both directions. The delivery and collection of load carriers does not require any automation of the workstation.

An embodiment and further advantages of the invention are explained below in connection with the following figures, in which:

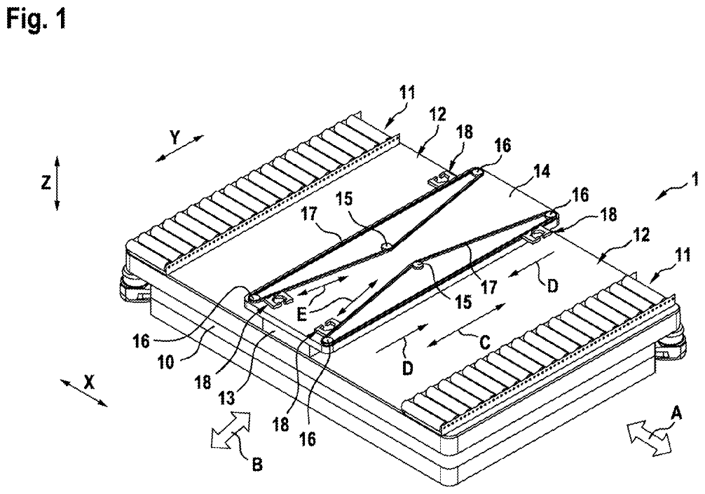

FIG. 1 is a perspective schematic representation of an automated guided vehicle according to the invention;

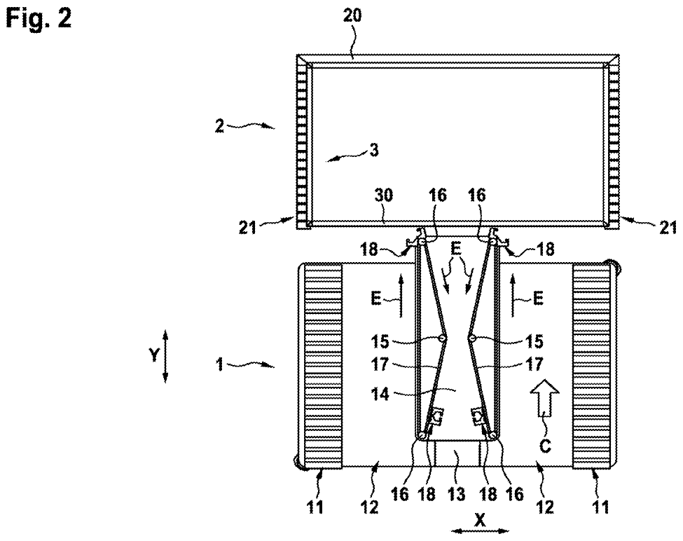

FIG. 2 is a schematic top view of the automated guided vehicle according to the invention laterally next to a workstation with extended displacement element and open gripper elements for a front engagement;

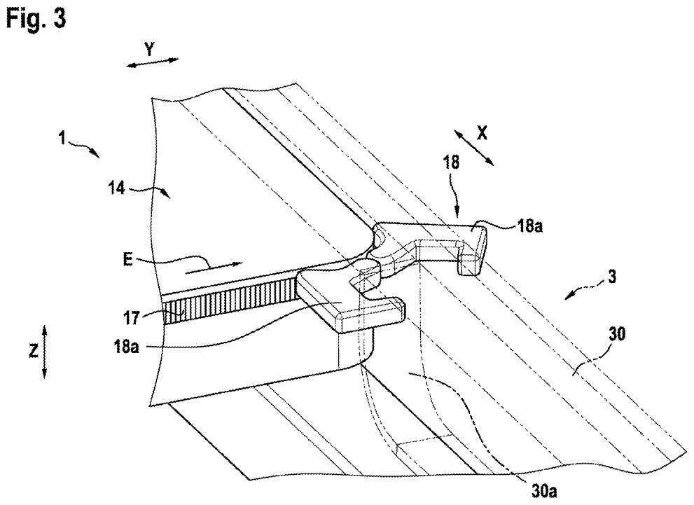

FIG. 3 is a perspective schematic detailed view of an open gripper element of the automated guided vehicle according to the invention;

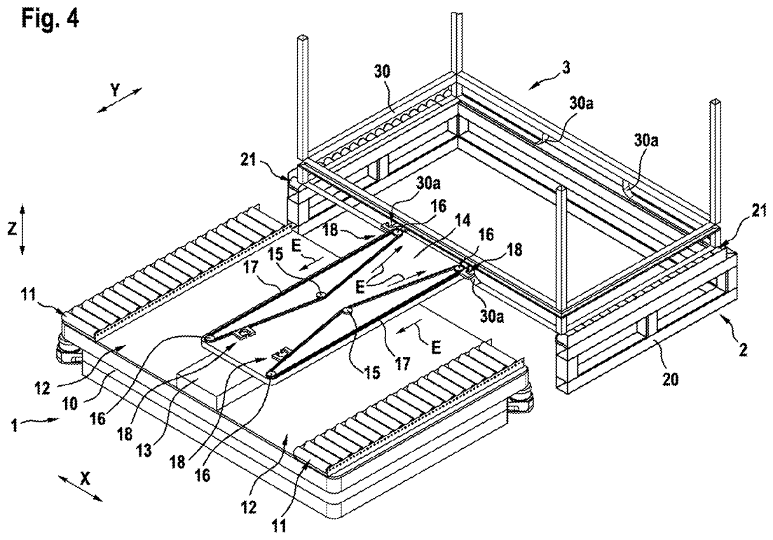

FIG. 4 is a perspective schematic representation of the automated guided vehicle according to the invention with open gripper elements in front engagement;

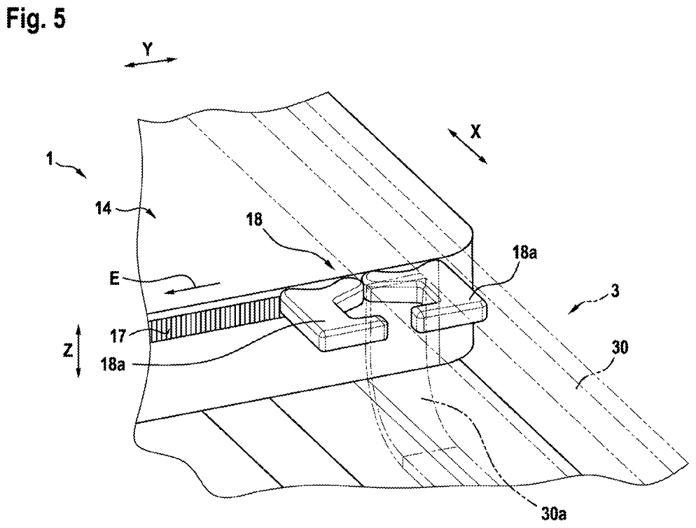

FIG. 5 is a perspective schematic detailed view of a closed gripper element of the automated guided vehicle according to the invention;

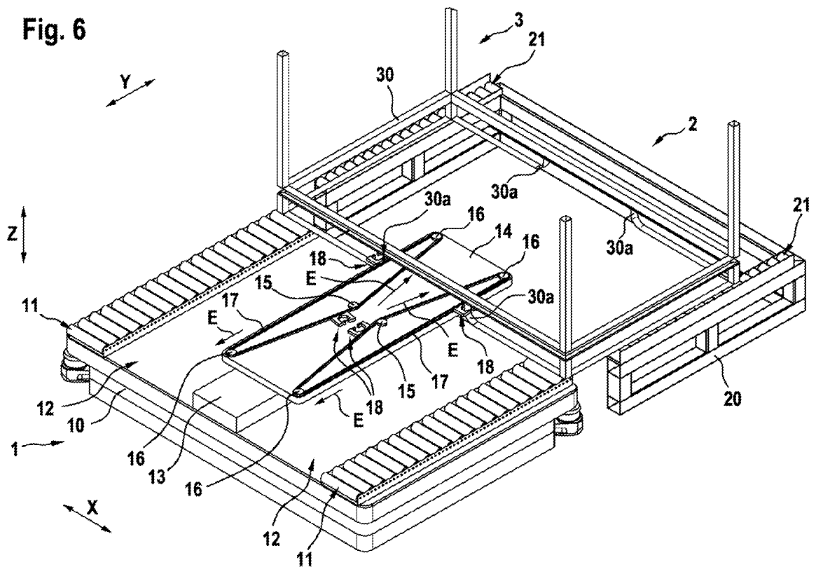

FIG. 6 is a perspective schematic representation of the automated guided vehicle according to the invention with moving gripper elements;

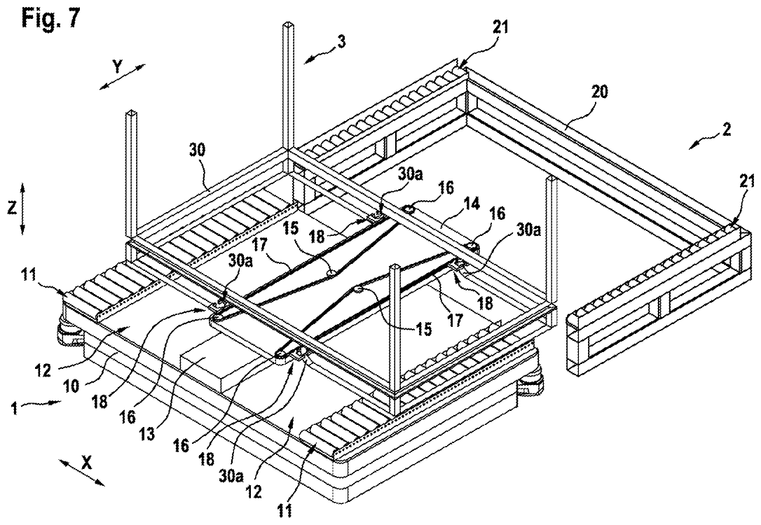

FIG. 7 is a perspective schematic representation of the automated guided vehicle according to the invention with a picked-up material handling accessory;

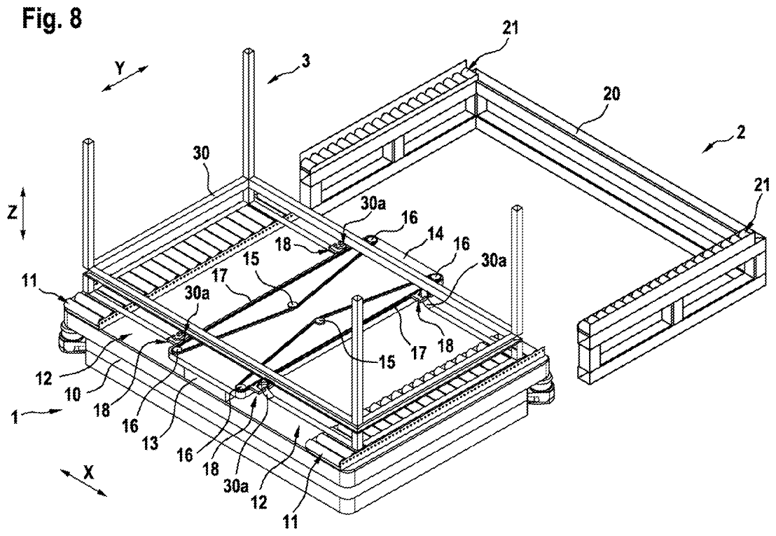

FIG. 8 is a perspective schematic representation of the automated guided vehicle according to the invention with retracted displacement element; and

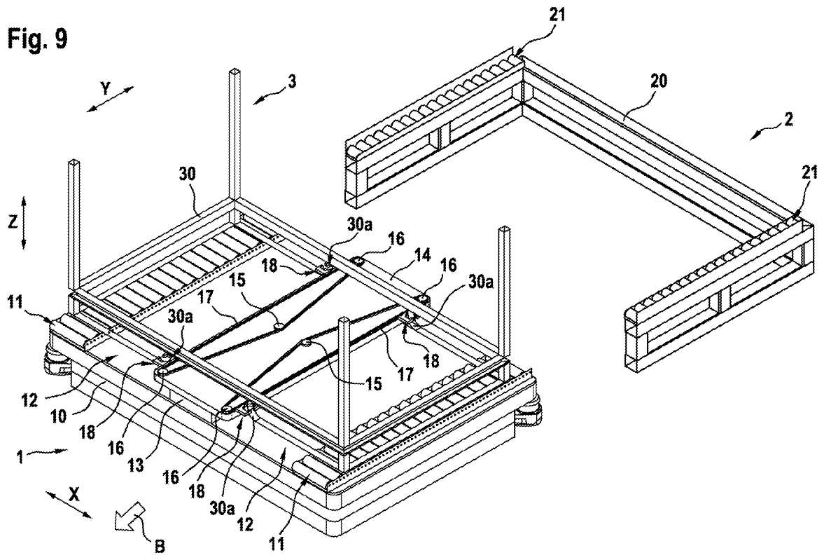

FIG. 9 is a perspective schematic representation of the automated guided vehicle according to the invention when being removed from the workstation.

The above figures are viewed in Cartesian coordinates. A longitudinal direction X is shown, which may also be referred to as the depth X or the length X. A transverse direction Y, which may also be referred to as the width Y, extends perpendicular to the longitudinal direction X. A vertical direction Z, which may also be referred to as the height Z, extends perpendicular to both the longitudinal direction X and the transverse direction Y.

FIG. 1 shows a perspective schematic illustration of an automated guided vehicle 1 according to the invention, which can be referred to as AGV 1 for short. The AGV 1 has a frame 10, which may also be referred to as a framework 10. The frame 10 is designed to be essentially rectangular and significantly flatter in the vertical direction Z than it is wide in the transverse direction Y and long in the longitudinal direction X. At two opposite corners of the frame 10, a laser scanner is arranged (shown, not labeled) which is used for optical detection of the surroundings.

Inside or below the frame 10, in addition to a control unit (not shown) and electrical power supply (not shown), a plurality of omnidirectional drives (not shown) are also provided which can move the AGV 1 horizontally on a surface (not shown) in all directions. As a result, the AGV 1 can be moved back and forth in a direction of travel A, which can be viewed as the preferred direction of movement and corresponds to the longitudinal direction X. Furthermore, the AGV 1 can be moved in a positioning direction B, which corresponds to the transverse direction Y, in both directions.

On the frame 10, two roller conveyors 11 are arranged on top in the vertical direction Z, which run parallel to one another, extend in the transverse direction Y over the entire width of the frame 10 and are arranged on the edge in the longitudinal direction X. A displacement element 14 is arranged centrally in the longitudinal direction X and likewise extends in the transverse direction Y and will be explained in more detail below. In the longitudinal direction X between the roller conveyors 11 and the displacement element 14, the upper side of the frame 10 in each case has a receiver 12 which is formed by a free space. Instead, further roller conveyors 11 can also be arranged in this region.

The previously mentioned displacement element 14 is movably connected in the transverse direction Y to a displacement element guide 13 by means of rails (not shown). The displacement element guide 13 itself is fixedly arranged on the upper side of the frame 10 and extends in the transverse direction Y as far as the corresponding outer edge of the frame 10. Compared to the displacement element guide 13, the displacement element 14 can be moved to both sides in the transverse direction Y by means of an electric drive (not shown), so that the displacement element 14 can protrude in the transverse direction Y over the corresponding outer lateral edge of the frame 10 as the external dimensions of said frame; see, for example FIGS. 2, 4, 6 and 7. In this way, the displacement element 14 can be moved out and in on both sides relative to the frame 10 in the transverse direction Y.

The displacement element 14 has a plurality of gripper elements 18, each of which has two gripper half-elements 18a. The displacement element 14 can therefore also be referred to as a gripper slide 14 or as a gripping table 14, and the displacement element guide 13 can also be referred to as a gripper guide 13. The gripper half-elements 18a are each formed essentially in the shape of a semicircle and each have a recess oriented towards one another. The two recesses in the gripper half-elements 18a together form a recess in the gripper element 18; see, for example, FIGS. 3 and 5. The two respective gripper half-elements 18a can be unfolded opposite one another and the gripper element 18 can thereby be opened; see, for example, FIGS. 2 to 4. The gripper element 18 can be closed by folding the two gripper elements 18a; see, for example, FIGS. 1 and 5 to 9.

The gripper elements 18 are each arranged in pairs on an endless closed drive element 17, which can be a drive belt 17, a drive chain 17 or a drive band 17. In the embodiment under consideration, two drive chains 17 can be used which run parallel to one another essentially in the transverse direction Y over the entire extent of the displacement element 14. The drive chains 17 are each guided around two deflection elements 16 in the form of deflection rollers 16, which are each provided with teeth or the like for engaging the chain elements of the drive chains 17. Both drive chains 17 can each be driven by means of a drive 15 in the form of a drive roller 15 and are also provided with teeth or the like. The drive rollers 15 are arranged approximately centrally in the transverse direction Y and set back from the lateral edge of the displacement element 14 in the longitudinal direction X, so that the two drive chains 17 have a slightly triangular course. The two drive rollers 15 can be driven synchronously via a common gear unit (not shown) by means of a common electric drive (not shown), so that the gripper elements 18 of the two drive chains 17 can be moved in the same direction of movement E and positioned identically.

The total of four deflection rollers 16 are arranged at the four corners of the displacement element 14, so that the two drive chains 17 run in the transverse direction Y over almost the entire extent of the displacement element 14 in the transverse direction Y along the edge. The four deflection rollers 16 and the two drive rollers 15 are each aligned in the vertical direction Z, i.e. the axes of rotation of the deflection rollers 16 and drive rollers 15 coincide with the vertical direction Z. In the vertical direction Z from above, the deflection rollers 16, the drive rollers 15 and the drive chains 17 are covered by a cover (not shown) which is fixedly connected to the displacement element 14. In this way, these elements 15-17 can be protected from soiling, damage, etc. Likewise, people can be protected from these movable elements 15-17.

Thus, the gripper elements 18 can, depending on their positioning by the movement of the corresponding drive chain 17, be positioned partially to completely outstandingly within the external dimensions of the displacement element 14 and thus below the cover or outside the external dimensions of the displacement element 14 and thus beyond the external dimensions of the displacement element 14; see, for example, FIGS. 7 to 9. With appropriate positioning, one gripper element 18 of each drive chain 17 can also be arranged inside and the other gripper element 18 outside the external dimensions of the displacement element 14; see, for example, FIGS. 1 to 6.

By means of a gripper element 18 of each drive chain 17, a material handling accessory 3 located at a workstation 2, which can also be referred to as a loading aid 3 or load carrier 3, can be gripped and by moving the gripper element 18 in a direction of movement E in the vertical direction Z can be pulled over the displacement element 14. When this movement is completed, the other gripper element 18 can likewise grip the load carrier 3 and thereby improve the hold of the load carrier 3. If the load carrier 3 is completely picked up on the displacement element 14, the displacement element 14 can be completely retracted over the frame 10 with one movement in a retraction direction D in order to pick up and transport the load carrier 3 within the external dimensions of the frame 10; see, for example FIGS. 8 and 9. All movements of the load carrier 3 relative to the frame 10 can be supported by its roller conveyors 11 as soon as the load carrier 3 comes into contact with its frame 30 or framework 30 with the outermost roller of the roller conveyors 11 facing said frame.

In this way, a load carrier 3 can be transported by the AGV 1 according to the invention to a workstation 2 and automatically transferred to this workstation 2 by performing the steps described above in reverse order. As described above, a load carrier 3 can also be picked up from a workstation 2 by means of an AGV 1 according to the invention. The load carriers 3 can in each case be empty or have parts, depending on the application.

In any case, according to the invention active cooperation of the workstation 2 is not necessary for this, so that corresponding active means such as drives, grippers and the like are not required by the workstation 2 and can be spared. In particular, a workstation 2 which was previously supplied with load carriers 3 by a person does not have to be changed in order to transfer this task to an AGV 1 according to the invention. Only passive means such as roller conveyors 21 can be helpful on the workstation 2 end; however, these can also be used when the workstation 2 is manually supplied with load carriers 3 and thus are already present.

As a method, an AGV 1 according to the invention can thus automatically travel to a workstation 2 in a direction of travel A, which, because of the omnidirectional drives, can be directed both back and forth in the longitudinal direction X and come to a stop aligned parallel to its roller conveyors 21. The AGV 1 can then approach the workstation 2 in one of the two positioning directions B in the transverse direction Y, so that the distance can be reduced enough to be able to grasp and pick up a load carrier 3 picked up by the workstation 2 according to the invention, cf., for example FIGS. 1 and 2.

In this position of the AGV 1, the displacement element 14 is now extended in the transverse direction Y in an extension direction C towards the load carrier 3. The two drive chains 17 have previously been driven and positioned in one of the two directions of movement E in such a way that in each case one gripper element 18 is positioned on the deflection roller 16 facing the workstation 2 in such a way that a gripper half-element 18a is sufficiently folded away in the longitudinal direction X from the associated other gripper half-element 18a to open the gripper element 18; see, for example, FIGS. 2 and 3.

If the displacement element 14 with the two open gripper elements 18 facing the workstation 2 is now extended further in the extension direction C of the transverse direction Y to the workstation 2 (see, for example, FIG. 2), two grip elements 30a of the frame 30 of the load carrier 3 go into the corresponding recess that is formed in each case by two open gripper half-elements 18a; see FIGS. 3 and 4.

The two drive chains 17 can now be moved in the direction of movement E in such a way that the previously described gripper element 18 moves laterally along the outside of the displacement element 14 towards the AGV 1. As a result, the particular grip element 30a of the load carrier 3, which can also be referred to as the vertical part 30a of the frame 30 or as the support element 30a of the frame 30, is in each case grasped from behind by a gripper half-element 18a and moved towards the frame 10 by its movement. The corresponding gripper element 18 closes as soon as the gripper element 18 has been moved beyond the deflection roller 16, whereby the corresponding grip element 30a of the load carrier 3 is enclosed on both sides by the gripper half-elements 18a of a gripper element 18; see, for example FIG. 5. The movement of the load carrier 3 is passively supported by the roller conveyors 21 of the frame 20 or framework 20 of the workstation 2.

In this constellation, in the course of the movement of the two drive chains 17 in the direction of movement E, the load carrier 3 is pulled towards the AGV 1 and, as soon as the distance in the transverse direction Y between the AGV 1 and the workstation 2 has been covered, its frame 10 also comes into contact with the roller conveyors 11 of the AGV 1, which from now on can passively support the further movement of the load carrier 3 towards the AGV 1 or onto the AGV 1.

The movement of the two drive chains 17 in the direction of movement E of the load carriers 3 towards the AGV 1 is continued until the further gripper element 18 has also come into engagement with the respective further grip element 30a of the load carrier 3. In this state, the load carrier 3 is completely received onto the displacement element 14 and is held approximately at the four corners of the displacement element 14; see FIG. 7. The displacement element 14 is then retracted in the direction of entry D towards the AGV 1, so that the displacement element 14 including the load carrier 3 that has been picked up is located within the external dimensions of the AGV 1 or its frame 10; see, for example, FIGS. 7 and 8.

The automatically loaded AGV 1 can now be moved away from the workstation 2 in the opposite positioning direction B in the transverse direction Y in order to get free from it; see FIG. 9. The AGV 1 can then move away from the workstation 2 in one of the two directions of travel A in order to transport the load carrier 3 to a destination. There, the picked-up load carrier 3 can be automatically deposited again in a manner analogous to the previously described manner. This can be done in the transverse direction Y on both sides.

### LIST OF REFERENCE SIGNS (PART OF THE DESCRIPTION)

A directions of travel of the automated guided vehicle 1
B positioning directions of the automated guided vehicle 1
C outward movement direction of the displacement element 14
D inward movement direction of the displacement element 14
E movement directions of the drive belts 17 or gripper elements 18
X longitudinal direction; depth; length
Y transverse direction; width
Z vertical direction; height
1 automated guided vehicle; AGV
10 frame; framework
11 roller conveyors
12 receivers
13 displacement element guide; gripper guide
14 displacement element; gripper slide; gripping table
15 drives; drive rollers
16 deflection elements; deflection rollers
17 (endless closed) drive elements; drive belts; drive chains; drive bands
18 gripper element
18a gripper half-elements
2 workstation
20 frame; framework
21 roller conveyors
3 material handling accessory; loading aid; load carrier
30 frame; framework
30a grip element, vertical part or support element of the frame 30

1. Automated guided vehicle having
a frame designed to receive a material handling accessory,
characterized by
at least one displacement element which is designed to be moved in and out in at least one horizontal direction relative to the frame at least to one side beyond the external dimensions of said frame,
the displacement element being further designed to carry the material handling accessory along with it.

2. The automated guided vehicle according to claim 1, characterized in that
the displacement element is designed to be moved in and out in at least one horizontal direction relative to the frame on both sides beyond the external dimensions of said frame.

3. The automated guided vehicle according to claim 1 or 2, characterized in that
the frame is designed to receive the material handling accessory in the vertical direction at least essentially, preferably completely, onto itself.

4. The automated guided vehicle according to claim 1, characterized in that
the displacement element is arranged in the vertical direction on top of the frame and below the received material handling accessory.

5. The automated guided vehicle according to claim 1, characterized in that
the displacement element is designed to automatically connect to the material handling accessory and to detach itself automatically from the material handling accessory.

6. The automated guided vehicle according to claim 1, characterized in that
the displacement element has at least one gripper element which is designed to grip the material handling accessory.

7. The automated guided vehicle according to claim 6, characterized in that
the displacement element has at least one drive element which is designed to move the gripper element in the horizontal direction relative to the displacement element at least on one side, preferably on both sides.

8. The automated guided vehicle according to claim 7, characterized in that
the drive element is an endless closed drive element which is guided essentially in the horizontal direction around at least one drive and around at least one deflection element.

9. The automated guided vehicle according to claim 8, characterized in that
the endless closed drive element is a drive belt, a drive chain or a drive band.

10. The automated guided vehicle according to claim 8, characterized in that
the gripper element has two gripper half-elements which are arranged on the endless closed drive element in order to be opened by the deflection of the endless closed drive element on the drive and/or on the deflection element and closed by the movement between the drive and the deflection element.

11. The automated guided vehicle according to claim 7, characterized in that
the gripper element is designed to be moved laterally by the drive element relative to the displacement element.

12. The automated guided vehicle according to claim 6, characterized in that
the displacement element has at least one pair of gripper elements, which are designed to jointly grip the material handling accessory,
the two gripper elements being arranged perpendicular to the horizontal direction of outward/inward movement spaced apart from one another.

13. The automated guided vehicle according to claim 6, characterized in that
the displacement element has at least one pair of gripper elements, which are designed to jointly grip the material handling accessory,
the two gripper elements being arranged spaced apart from one another in the horizontal direction of the outward/inward movement.

14. The automated guided vehicle according to claim 13, characterized in that
the two gripper elements on a common drive element are arranged spaced as far apart from one another as two corresponding grip elements of the material handling accessory are arranged spaced apart from one another in the horizontal direction.

15. The automated guided vehicle according to claim 1, characterized in that
the frame has at least one roller conveyor, preferably at least one pair of roller conveyors, which is designed to receive the material handling accessory by rolling.
